(19) United States
(12) Patent Application Publication
(10) Pub. No.: US 2015/0006081 A1
(43) Pub. Date: Jan. 1, 2015

(54) ADAPTIVE TIME-LAPSE SUB-SURFACE ELECTRICAL RESISTIVITY MONITORING

(71) Applicant: Subsurface Insights LLC, Hanover, NH (US)

(72) Inventor: Roelof Jan Versteeg, Hanover, NH (US)

(21) Appl. No.: 13/932,207

(22) Filed: Jul. 1, 2013

(51) Int. Cl. G01V 3/38; G01V 3/02

(52) U.S. Cl. CPC G01V 3/38; G01V 3/02
USPC 702/7

(57) ABSTRACT

A computer-based method includes receiving a first data set of electrical resistivity measurements from a plurality of electrodes arranged to measure electrical resistivity in or around a subsurface area of interest using a first set of acquisition parameters, processing, with one or more computer-based processors, the first data set of electrical resistivity measurements using a first set of processing parameters to produce a first multi-dimensional model of electrical resistivity in the subsurface area of interest; and modifying one or more of the acquisition parameters or one or more of the processing parameters.

### GOVERNMENT LICENSE RIGHTS

This invention was made with government support under two Phase I SBIR grants: DE-SC0010234, Hydrogeophysical Monitoring System and DE-SC0009732, Multiscale Hydrogeological-Biogeochemical Process Monitoring and Prediction Framework, awarded by the Department of Energy. The government has certain rights in the invention.

### FIELD OF THE INVENTION

This invention is related to time-lapse, sub-surface monitoring and, more particularly, time-lapse monitoring of subsurface electrical resistivity.

### BACKGROUND

This section provides the reader with a background of technology and previous art related to time lapse electrical geophysical monitoring in the context of this disclosure. This section also identifies and provides context for several shortcomings in prior technology, and provides context how the prior technology could and will benefit from the system and method described in this disclosure. Simply because information appears in this section should not be taken as indicating its presence in the prior art. This section also provides context for certain significant improvements described and claimed in this disclosure.

In many applications which involve the subsurface, including but not limited to production of hydrocarbon resources, contaminant remediation, water management for agricultural, industrial and drinking water purposes and civil engineering efforts, there is commercial, regulatory and/or operational value in having timely and actionable information on subsurface physical, and biological processes. A non-comprehensive list of processes of interest include reducing and oxidizing processes, dissolution, precipitation, compaction and movement of liquids and gas. More generally speaking, knowledge of the spatial and temporal behavior of each subsurface process which affects human activities in either a positive or negative manner will have commercial, regulatory and/or operational value.

The specific behavior and evolution of these processes results from the combination of physical, chemical and biological properties of the subsurface and external forcing functions. Both these properties and the forcing functions can have either natural and/or anthropogenic origins. Forcing functions include but are not limited to weather related forcing functions (e.g., rainfall, daily and seasonal temperature variations, atmospheric pressure), subsurface chemical or biological gradients, hydrological gradients (including those resulting from the injections or extractions of liquids), thermal gradients resulting from heating or cooling of the subsurface and pressure gradients. Forcing functions are typically temporally and spatially variable, with their behavior and variability generally not known a priori.

One common way to obtain information on subsurface processes of interest is through the use of geophysical methods in so called timelapse mode. Geophysical methods can be used to obtain an estimate of the spatial distribution of values of subsurface physical properties through a three step process. These steps are (a) geophysical data collection, (b) preprocessing of the field data, and (c) inversion. This estimate of the spatial distribution of physical properties resulting from this three step process is not a perfect representation of the actual physical properties of the subsurface due to several factors. These factors include (a) geophysical methods are by their nature limited in the amount of detail which they can resolve, (b) in addition to the method imposed limitation the amount of data collected in a survey can limit the resolution and (c) the inversion step is non-unique.

If geophysics is used in a timelapse mode, geophysical data sets are collected across the same location multiple times. Each dataset will result (through the processing and inversion process listed above) in a spatial distribution of one or more properties of interests. The temporal change in property distributions can be used to identify and investigate processes of interest. Different geophysical modalities have been used for time lapse studies to investigate a range of different processes. For instance, U.S. Pat. No. 5,798,982 (1998) discloses a method for using 4-D seismic data to identify subsurface fluid flow in hydrocarbon reservoirs, and U.S. Pat. No. 5,357,202 (1994) discloses a method for locating the presence of leaks from containment vessels by measuring subsurface changes in the conductivity of the soil.

Electrical geophysical methods (which include the DC resistivity, induced polarization (IP), and self-potential or spontaneous potential (SP) methods) is one group of geophysical methods which can be used in a time lapse mode. Electrical geophysical methods are well suited to be used in a time lapse mode due to the acquisition methodology in which electrodes can be semi-permanently emplaced along the surface or in boreholes. Electrical geophysical methods have been shown to be relevant to the investigation of subsurface processes of interest as the physical property which is mapped by electrical methods (i.e., electrical resistivity) is affected by both physical, chemical and/or biological subsurface processes. The term electrical resistivity is used here as being shorthand for complex electrical resistivity, defined as anisotropic, frequency-dependent, real and imaginary electrical resistivity.

In the application of electrical geophysical methods measurements are made by an electrical geophysical data acquisition unit which is connected to electrodes which are placed along the surface or along boreholes in the vicinity of the area which is of interest. A survey is made by performing a sequence of measurements in which each measurement corresponds to a combination of current electrodes (also known as injection electrodes) and potential electrodes (also known as measurement electrodes) and associated acquisition parameters. The resulting dataset, which can consist of any number of measurements, is commonly known as an electrical geophysical survey dataset. The time required for the collection of such a dataset depends on a combination of the instrument used, acquisition parameters and the total number of electrodes used in the survey. Typical collection times range from several minutes to several days.

Electrical geophysical measurements can either be made in a passive mode (for the self-potential method) or in an active mode (DC resistivity and induced polarization methods). In the self-potential method, a naturally occurring voltage potential is being measured between pairs of potential electrodes. In the DC resistivity and induced polarization methods, current flow in the subsurface is induced by applying a voltage over one or more pairs of current electrodes. A measurement consists of the combination of the measurement of the induced current and the resulting voltage potential differences as measured over pairs of measurement electrodes. In the DC resistivity method the induced voltage is only measured during the on time of the current injection. In the induced polarization method, the induced voltage is measured both during both the on and off part of the current injection.

An electrical geophysical survey dataset resulting from the application of electrical geophysical methods is used to generate a multidimensional distribution of electrical properties through a data processing sequence which includes a data preprocessing step followed by an inversion step. In the inversion step (which is executed through a computer program) a distribution D of electrical properties is found which minimizes the difference between simulated forward electrical geophysical data calculated from this distribution D and the data in the electrical geophysical dataset. This difference is known as the cost function.

An electrical geophysical survey dataset by itself does not provide enough information to uniquely characterize the true distribution of electrical resistivity in the subsurface. Specifically, if one solution to the unconstrained inverse problem exist then an infinite number of solutions exist. Thus, the distribution of electrical resistivity resulting from an unconstrained inversion is non-unique.

To address this non-uniqueness electrical resistivity inversion in practice includes constraints and regularizations as part of the cost function. Constraints and regularizations ensure that the distribution of properties resulting from the inversion process will have certain characteristics. These characteristics could be that a model is maximally smooth, have specific values at known locations (for instance along a borehole), or have correlation lengths or structures similar to known subsurface structures.

Using constraints the object of electrical resistivity inversion is to find a distribution of electrical properties σₑₛₜ which minimizes a function Φ, given by Φ=Φ_{d}(u_{d})+βΦₘ(uₘ) (1). In equation (1) Φ_{d} is an operator giving a scalar measure of the misfit between observed and simulated electrical properties (resistivity (or its inverse conductivity) and chargeability) according to a desired norm, Φₘ is the corresponding scalar measure of the difference between σₑₛₜ and constraints placed upon the structure of σₑₛₜ and β is a regularization (or trade off) parameter that controls the contribution of Φₘ to Φ in comparison with Φ_{d}.

The results of the standard inversion process thus depend both upon the measured data and the parameterization of the inversion process. This parameterization includes (but is not limited to) the initial resistivity model, the constraints applied to the model, and the convergence criteria.

In time lapse inversion, in which multiple electrical geophysical survey datasets are being collected and processed, additional regularizations and constraints are generally added to those used in the inversion of a single electrical geophysical survey dataset. Such constraints and regularizations are based on certain assumptions on the behavior of processes. An example would be to assume minimum or smooth changes in physical properties between surveys, or changes in physical properties which correlated with changes in known processes (e.g. movement of groundwater). Subsurface characterization data (e.g., well log data and seismic data) is generally used as part of the inversion process. If temporal physical, chemical or biological data (e.g., information on subsurface fluid level, chemistry, biological activity, temperature or electrical conductivity) and data on forcing functions (e.g., environmental information and/or information on injection/extraction of fluids) is available, this data can also be used to constrain time lapse inversions.

In the application of time lapse electrical resistivity studies, the correct and timely identification of subsurface processes is one of the primary objectives. Achieving this objective requires a correct choice of both a measurement sequence and associated inversion process parameterization and the timely and actionably communication of the resulting information to end users and stake holders. As the spatial and temporal characteristics of subsurface processes change over time, such timely and correct identification will requires different measurement sequences and inversion parameters for different electrical geophysical survey datasets.

Similarly, as the dimensionality of the ways in which results of timelapse electrical monitoring can be calculated and reported on increases with the number of electrical geophysical survey datasets a singular, predefined representation of such results does not allow for the optimal representation of such results. For example, in the case where a time lapse electrical geophysical survey has one hundred datasets and where the results are being presented as the difference between an initial distribution of electrical resistivity obtained from the initial survey and subsequent distributions of electrical resistivity this presentation will generally not allow for the easy identification of subtle changes between later distributions of electrical resistivity which are of interest to the monitoring objective.

### SUMMARY OF THE INVENTION

The invention is defined by the language of the claims. The description given in this and in subsequent sections simply represents different example embodiments. Unless explicitly required by their language, the claims are not limited to the listed example embodiments, and it will be apparent to those having ordinary skill in the art that various changes can be made to the example embodiments while not departing from the spirit or scope of the claims. All such modifications are encompassed by this disclosure.

Embodiments of the present invention are directed to systems and methods for mapping subsurface processes by obtaining an accurate representation of changes in subsurface electrical properties. The present invention is intended for use in conjunction with methods and instruments for collecting time lapse electrical geophysical and auxiliary physical, chemical and environmental time series data such that a complete subsurface process detection, characterization and reporting solution is provided.

In one aspect, a computer-based method includes receiving a first data set of electrical resistivity measurements from a plurality of electrodes arranged to measure electrical resistivity in or around a subsurface area of interest using a first set of acquisition parameters; processing, with one or more computer-based processors, the first data set of electrical resistivity measurements using a first set of processing parameters to produce a first multi-dimensional model of electrical resistivity in the subsurface area of interest; and modifying one or more of the acquisition parameters or one or more of the processing parameters.

In one embodiment, a system is disclosed for adapting the data acquisition parameters of electrical geophysical surveys. Data collected by electrical geophysical resistivity hardware located at a field site are transmitted to an analysis computer. This data and auxiliary physical, chemical and environmental data is processed and novel acquisition parameters are transmitted to the field hardware which then will use these novel parameters for acquisition of subsequent data. This process can be performed each time new data is received at the analysis computer.

In another embodiment, a system is disclosed for adapting the data processing parameters for an electrical geophysical survey dataset. Data collected by electrical geophysical resistivity hardware located at a field site are transmitted to an analysis computer. This data and auxiliary physical, chemical and environmental data is processed using geophysical, hydrological and geochemical forward and inverse codes. The parameters used in this processing are adapted as a function of both the electrical geophysical data and the auxiliary data.

In an additional embodiment, a system is disclosed for transmission, validation, management, storage of and user interaction with time-series electrical geophysical and auxiliary data as well as the results of the processing of such data. Data is collected by different data acquisition devices. Data is collected at a central computer in a number of manners. Data is validated and stored in a structured format. Raw and processed data are provided to users in a plurality of forms and are automatically ranked in terms of relevancy to the monitoring and information objectives. Users can interactively query the multidimensional data cube for features of interest based on certain data attributes and information objectives.

The foregoing has outlined rather broadly the features and technical advantages of the present techniques in order that the detailed description of the present techniques that follows may be better understood. Additional features and advantages of the present techniques will be described hereinafter which form the subject of the claims of the present techniques. It should be appreciated by those skilled in the art that the conception and specific embodiment disclosed may be readily utilized as a basis for modifying or designing other structures for carrying out the same purposes of the present techniques. It should also be realized by those skilled in the art that such equivalent constructions do not depart from the spirit and scope of the present techniques as set forth in the appended claims. The novel features which are believed to be characteristic of the present techniques, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present techniques.

In some implementations, one or more of the following advantages are present.

For example, some implementations provide for enhanced and more accurate imaging of spatial and temporal changes in subsurface electrical resistivity as well as for improved ease and timeliness with which stakeholders can access information on the changes.

Other features and advantages will be apparent from the description and drawings, and from the claims.

### BRIEF DESCRIPTION OF THE DRAWINGS

FIG. 1 is a flow diagram in which data acquisition parameters for electrical geophysical data are modified.

FIG. 2 is a flow diagram in which data processing parameters for electrical geophysical data are modified.

FIG. 3 is a flow diagram showing calculation of data acquisition parameters based on assumed, estimated or known spatial and temporal changes in subsurface electrical properties

FIG. 4 is a flow diagram in which future data acquisition parameters for electrical geophysical data are modified.

FIG. 5 shows the elements involved in a single electrical geophysical measurement.

FIG. 6 includes graphs showing applied voltage and received voltage for a resistivity measurement over time.

FIG. 7 show examples of numbering schemes associated with resistivity electrodes connected to multi electrode resistivity instruments and three resistivity measurement sequences taken with different combinations of electrodes.

FIG. 8 shows a multielectrode electrical resistivity system deployed for the study of a subsurface process with electrodes deployed at the surface and in boreholes.

FIG. 9 shows a timelapse resistivity survey which consists of multiple resistivity datasets.

FIG. 10 shows a flowchart of 4D resistivity inversion.

FIG. 11 shows the change in apparent resistivity for a single resistivity measurement over a 14 month period.

FIG. 12 shows the change in apparent resistivity for a single resistivity measurement over a 17 day period.

FIG. 13 shows temperature variations from four temperature sensors placed across an air/soil interface.

FIG. 14 shows the variation of apparent resistivity of a timelapse resistivity survey and an associated change in waterlevel over the area in which the timelapse survey is being conducted.

FIG. 15 depicts a block diagram of a computer system that is adapted to use the present techniques.

FIG. 16 depicts some of the different dataproducts which can be formed from a timelapse dataset.

FIG. 17 shows a screenshot of an example computer based interface used to interact with the system.

FIG. 18 is a schematic diagram of an exemplary computer system.

FIG. 19 is a schematic diagram of an exemplary modeling system from FIG. 18.

FIG. 20 is a flow chart of a method associated with the computer system of FIG. 18.

### DETAILED DESCRIPTION

This invention is defined by the language of the claims. The description given in this and subsequent sections and illustrated in the drawings represented above simply represent different example embodiments. Unless explicitly required by their language the claims are not limited to the listed example embodiments and it will be apparent to those having ordinary skill in the art that various changes can be made to the example embodiments while not departing from the spirit or scope of the claims. All such modifications are encompassed by this disclosure.

In some situations, suboptimal data acquisition and processing parameters may reduce the quality, accuracy and/or value of information on subsurface processes which can be obtained from timelapse electrical geophysical inversion. Furthermore, the lack of tools allowing end users to easily and in a timely manner access and interact with all the information (rather than a fixed and/or limited subset of such information) resulting from timelapse electrical geophysical surveys may further reduce the value of this information. Improving the quality, accuracy and value of information on subsurface processes can be done by different techniques. For instance, one technique involves optimizing the data acquisition parameters such that data is collected which best captures these subsurface processes. Another technique involves optimizing the data processing parameters for datasets so that the model resulting from the inversion gives the most accurate representation of subsurface properties and subsurface processes. A third technique allows automated or interactive identification of relevant features in processed datasets and the reporting of such features through text based or visual representations.

As used herein, a “model” generally refers to a computer-based representation of the spatiotemporal distribution of electrical resistivity throughout a subsurface earth volume. Depending on the context, such a model may be represented in 1-D, 1.5-D, 2-D, 2.5D, 3D, 3.5 D, 4D and in general N Dimensional space. For instance, the 4D space may contain the different distributions from a number of separate datasets, and the 5D space may contain the differences between such distributions. Various geometrical descriptions are possible for one, two, three or four-dimensional models. Some examples in three dimensions include uniform or non-uniform hexagonal cells, tetrahedral cells, or two-dimensional surfaces. In a cell-based description, the properties may be either the volume of each cell or associated with the corner of each cell and include an interpolation rule for how the properties are to vary within a cell. In a description based on surfaces, the properties may be associated with the subsurface region above or below the surface.

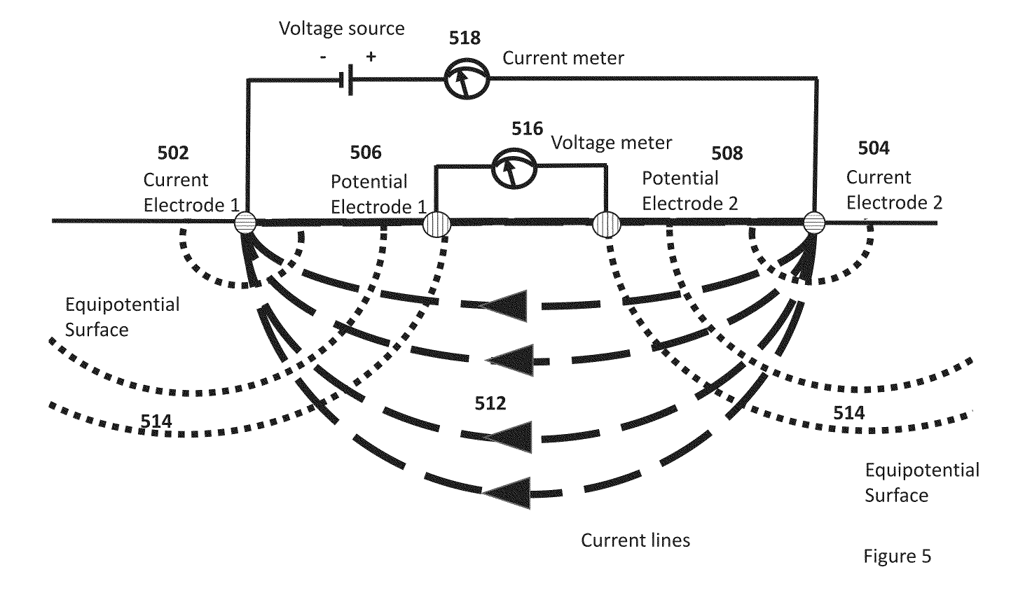

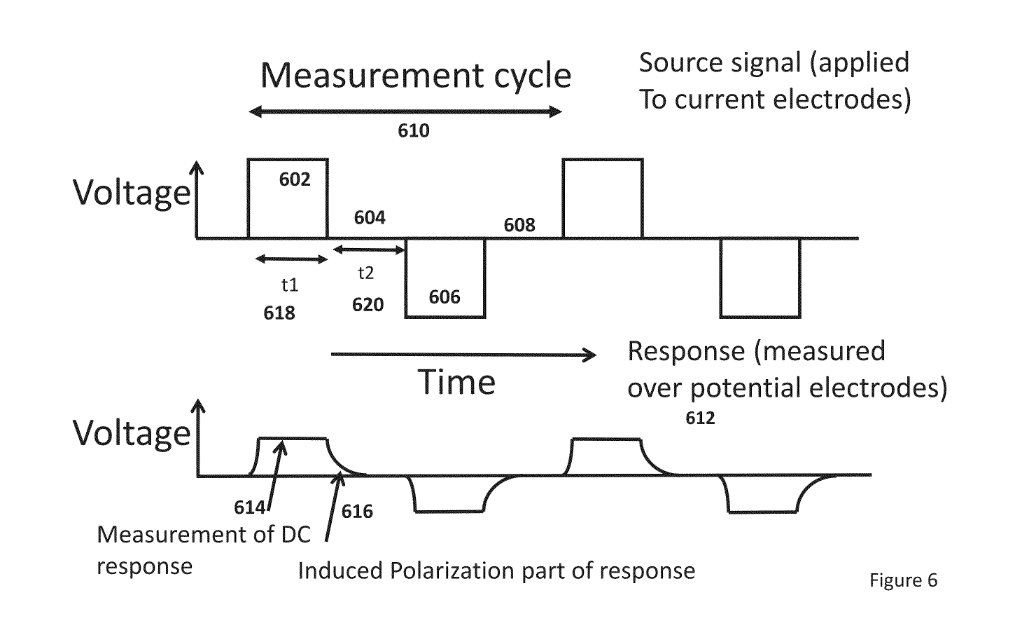

As used herein, an “electrical geophysical measurement” generally consists of data collected by an electrical resistivity instrument. An illustration of one configuration for such a measurement which uses two current electrodes (also known as injection or source electrodes) (Current Electrode 1—502 and Current Electrode 2—504) and two potential electrodes (also known as measurement electrodes) Potential Electrode 1 (506) and Potential Electrode 2 (508) is shown in FIG. 5, with the associated signal for both the current electrode and potential electrodes shown in FIG. 6.

In a measurement an initial voltage is applied between the Current Electrode 1 (502) and the Current Electrode 2 (504) by the voltage source 510. This voltage (602) is represented in the top diagram in FIG. 6. The voltage has a finite duration and is often a square wave. In response to this voltage current (512) will flow between the two current electrodes 502 and 504 and a voltage potential field will form within the earth with equipotential surfaces 514 which are perpendicular to the current field. The potential field which exists between the potential electrodes 506 and 508 is then measured by voltmeter 516. At the same time the amount of current which flows between the current electrodes 502 and 504 is measured by a current meter 518.

A measurement cycle (610) of a measurement generally consists of the voltage which is being applied over the current electrodes being an initial voltage 602 which is applied for a certain time t1 (618) followed by a zero voltage 604 which is applied for a time t2 followed by a voltage 606 which is of opposite polarity to the voltage 602 and which is applied for a time t1 followed by a zero voltage 608 which is applied for a time t2. The total length of a measurement cycle is thus Tmeas=2t1+2t2. The frequency of such a cycle is given by the f=1/Tmeas. It is common but not required for t1 and t2 to be identical. Thus, if t1 and t2 are 25 milliseconds the frequency of the measurement would be 10 Hz. The response to the voltage excitation is a potential difference 612 over the potential electrodes. This response varies in time with the same frequency as the source signal. The response has a component which corresponds to the ON time of the source signal (the ON time is the time when the voltage over the current electrodes is not zero), and a component which corresponds to the OFF time of the source signal (when the voltage over the current electrodes is zero). The OFF time response is generally known as the Induced Polarization response.

In order to improve the data quality of a measurement it is common to collect multiple measurement cycles and add the resulting data to improve the Signal to Noise (S/N) ratio. The number of measurement cycles used in an individual measurement is known as a stack. The ratio t1/(t1+t2) is known as the duty cycle.

Associated with such a measurement are different settings including (but not limited to) settings related to the voltage and current provided by the current source, the frequency of the current source, the number of stacks, and the duty cycle. These and possibly other settings are collectively known as measurement configuration settings.

While this description presents information in the context of DC resistivity and Induced Polarization measurements this description and invention also covers self-potential measurements for which we effectively omit the current electrodes and only measure the naturally occurring electrical potential field.

Other resistivity measurement configurations than those using two current electrodes and two potential electrodes are possible including, for example, configurations in which multiple potential electrodes are simultaneously used and/or configurations in which multiple current electrodes are simultaneously used to make a resistivity measurement.

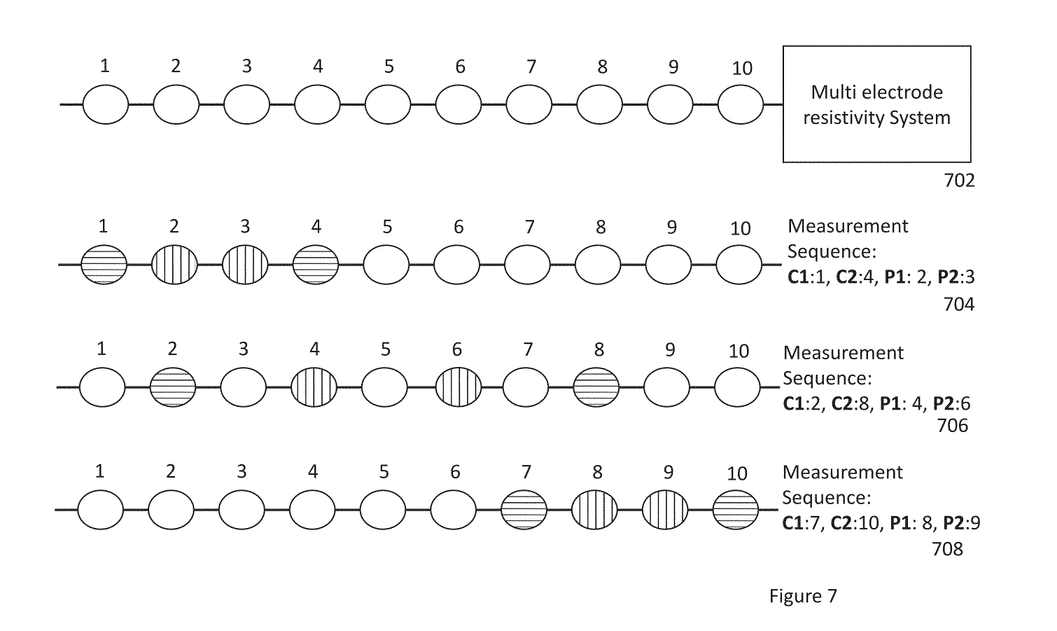

In a typical multi-electrode resistivity system, each electrode connected to the resistivity system is uniquely identified within the system. Such an identification scheme and an associated measurement scheme is shown in FIG. 7. 702 shows an exemplary identification system using an integer based numbering scheme. Other numbering schemes are possible.

In a typical multi-electrode resistivity system, each resistivity measurement is done using a combination of current electrodes and potential electrodes. 704 shows one example of such a combination in which electrodes with number 1 and 4 are used as current electrodes, and electrodes with numbers 2 and 3 are used as potential electrodes. 706 shows another example of such a combination in which electrodes with number 2 and 8 are used as current electrodes, and electrodes with numbers 4 and 6 are used as potential electrodes. 708 shows another example of such a combination in which electrodes with number 7 and 10 are used as current electrodes, and electrodes with numbers 8 and 9 are used as potential electrodes.

As used herein, “dataset acquisition parameters” generally refers to an ordered list of measurements (with associated current and potential electrodes) to be collected by the electrical resistivity instrument associated with measurement acquisition parameters. The position in the list may determine the order in which data is collected.

An example of such a list (consisting of three measurements) would be the measurements shown in 704, 706 and 708. In FIG. 7 one instrument would perform these three sets of measurements, by selecting the appropriate electrodes from among the electrodes connected to the instrument.

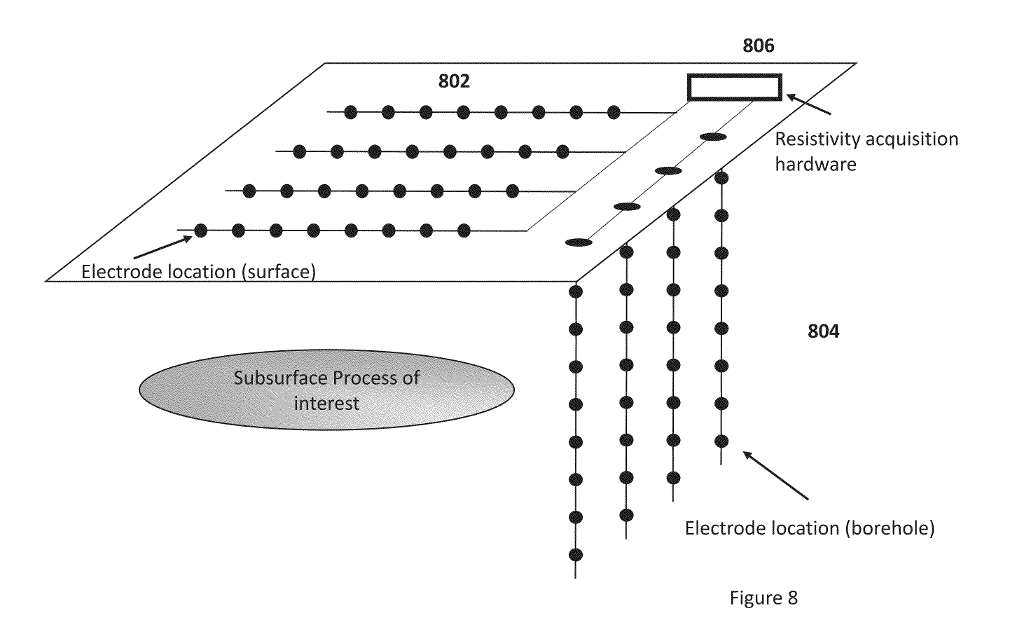

In a timelapse electrical resistivity survey electrodes are deployed along locations around the subsurface process of interest. An example of such a deployment is shown in FIG. 8. In such a deployment electrodes can be deployed both at the surface 802 and in the subsurface 804. The electrodes are connected to resistivity acquisition hardware 806.

An electrical geophysical resistivity survey dataset consists of a number of ordered electrical geophysical measurements collected using for example a configuration showed in FIG. 8 and a sequence shown in FIG. 7.

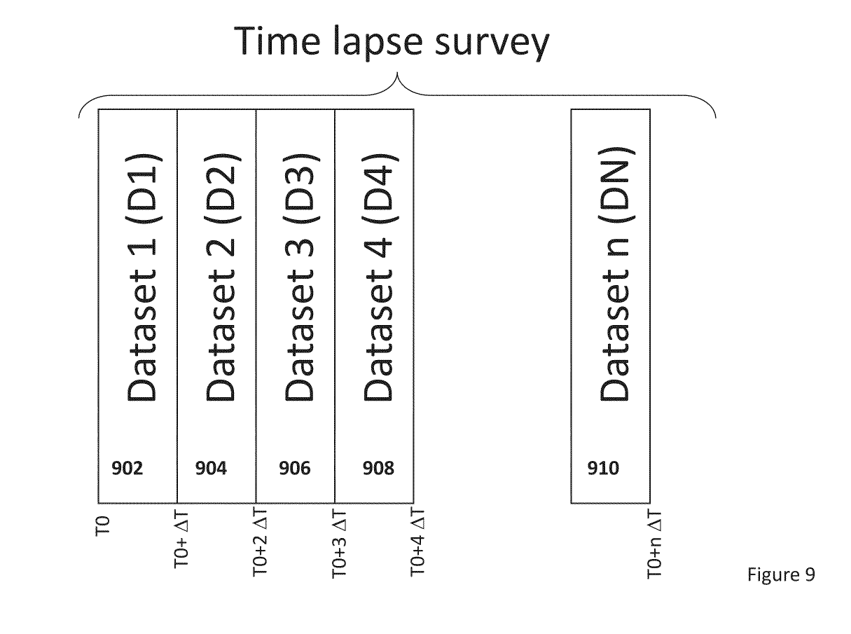

A timelapse survey (FIG. 9) consists of a number of such electrical geophysical resistivity survey datasets which are collected consecutively in time. In FIGS. 9, 902, 904, 906, 908 and 910 represent individual surveys, each of which is composed of multiple electrical geophysical measurements.

In the inversion process, which maps an electrical geophysical resistivity survey data set to a 2D or 3D distribution of electrical properties, a resistivity model is found which best fits the collected data, while simultaneously obeying, for example, a smoothness constraint and/or other constraints, such as a priori subsurface resistivity information. Such a resistivity model may be represented, for example, either as a single distribution or in the form of a PDF (Probability Density Function), and that inversion could be implemented either as a deterministic or stochastic inversion. A typical assumption of this inversion process is that the relative fluctuation of the subsurface electrical properties during the data acquisition are small. While a precise threshold of acceptable fluctuations within which the inversion process will work as accepted may depend on multiple factors, including, for example, the parameters of the inversion process, in general fluctuations of less than 1% are preferred, whereas fluctuations of more than 10% in the electrical properties of the subsurface may lead to substantial errors in the inversion process.

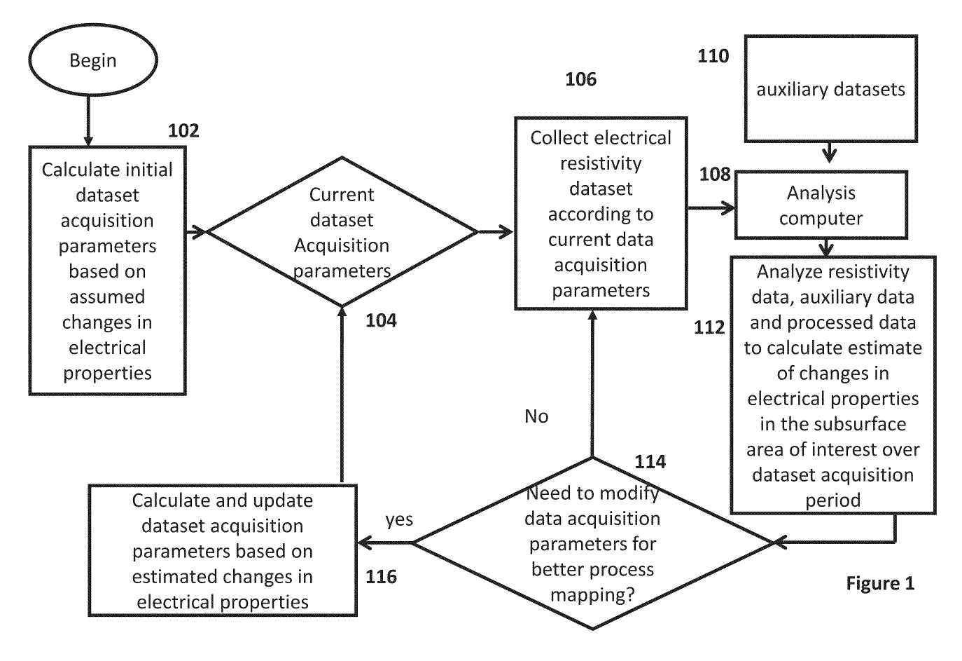

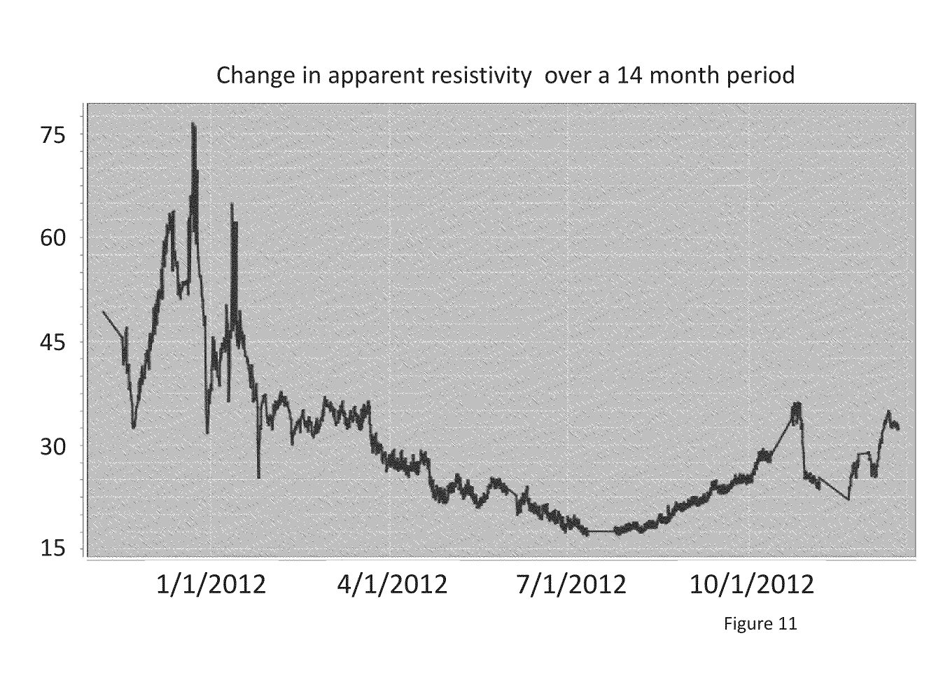

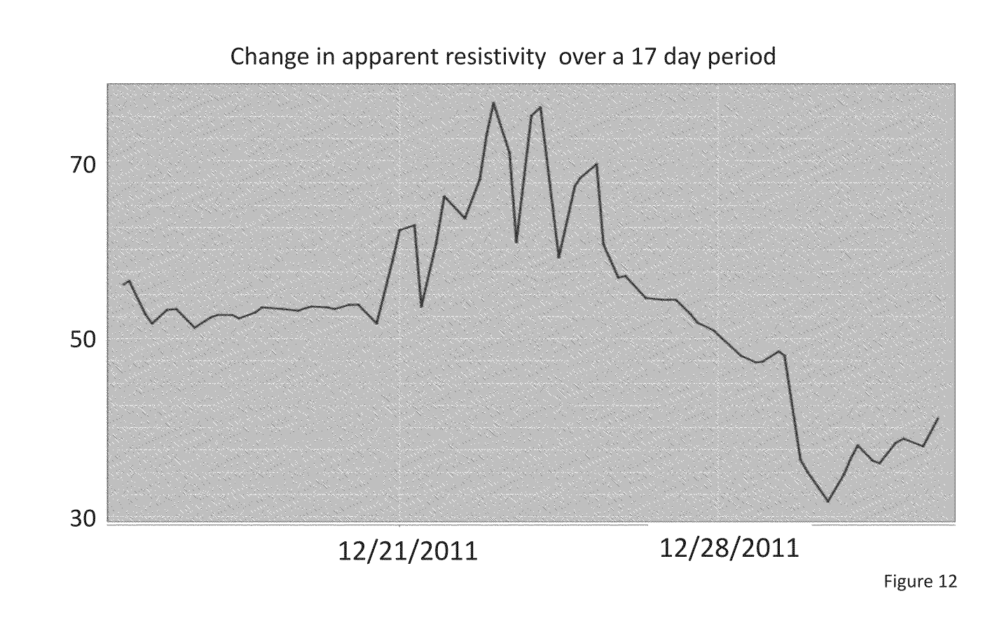

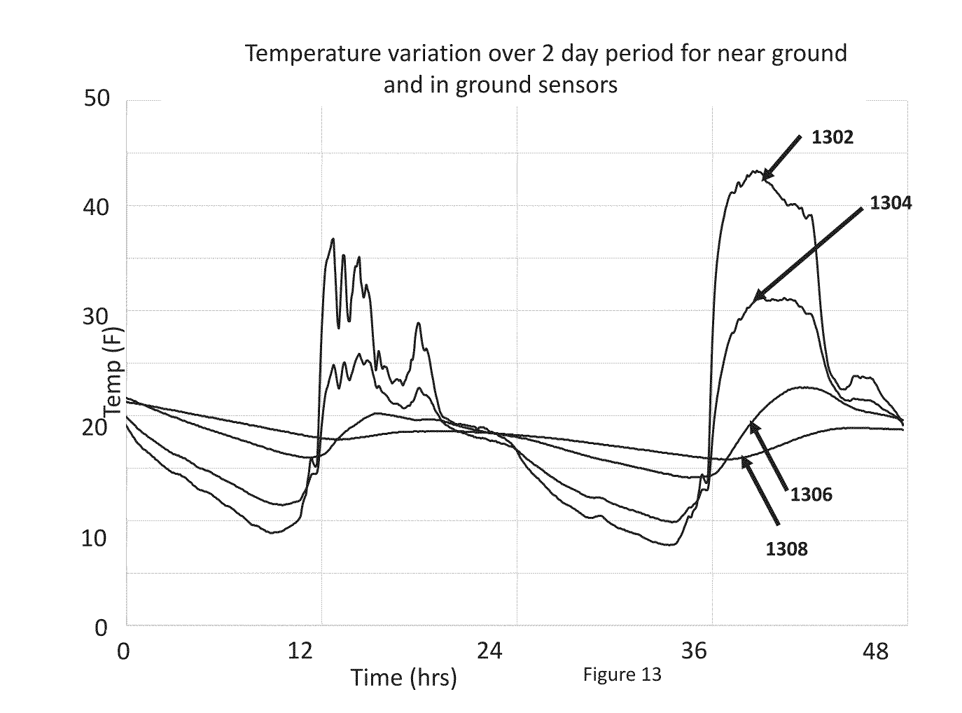

One embodiment is aimed at ensuring that the assumption of small changes in measurements is honored for time lapse resistivity datasets. An example of this embodiment is shown in FIG. 1. In this embodiment, initial dataset acquisition parameters are calculated (102) for a specific distribution of electrodes which have been placed along the surface and/or in boreholes to study and monitor a specific subsurface process of interest. This calculation is done using a numerical forward model and associated sensitivity analysis of the placement of electrodes and associated measurement scheme to some expected fluctuation of complex electrical resistivity. The result of this calculation is stored as “current dataset acquisition parameters” (104). Subsequent to the initial calculation an electrical resistivity dataset is collected (106). This dataset is transmitted to an analysis computer (108). This transmission can either take the form of transmission of individual measurements (in which the results of an individual measurement are sent to the analysis computer at completion of such a measurement), transmission of blocks of measurements (e.g., 10 or 20 measurements) or transmission of all the data in a dataset. FIGS. 11 and 12 show an example of the variation of apparent resistivity for one such measurement over a period of 14 months (FIG. 11) and 17 days (FIG. 12). The analysis computer also may collect auxiliary datasets which provide information on changes in subsurface physical properties. Such auxiliary datasets may include data from in ground and above ground physical, chemical and biological sensors such as weatherstations and temperature sensors. An example of such a dataset is shown in FIG. 13. In FIG. 13 four temperature profiles are shown over a two day period. 1302 corresponds to a sensor placed in the air. 1304 corresponds to a sensor placed at the air/soil interface. 1306 corresponds to a sensor placed at a depth of 10 cm in the soil. 1308 corresponds to a sensor placed at a depth of 20 cm in the soil. The analysis computer uses the resistivity data, auxiliary data 110 and processed resistivity data to calculate an estimate of changes in electrical properties in the subsurface area of interest over the data acquisition period (112). These changes are transmitted to analysis logic (114) which decides whether the data acquisition parameters need to be modified. If the data acquisition parameters need to be modified, new dataset acquisition parameters are calculated (116) and the data acquisition parameters used by the system are updated (104).

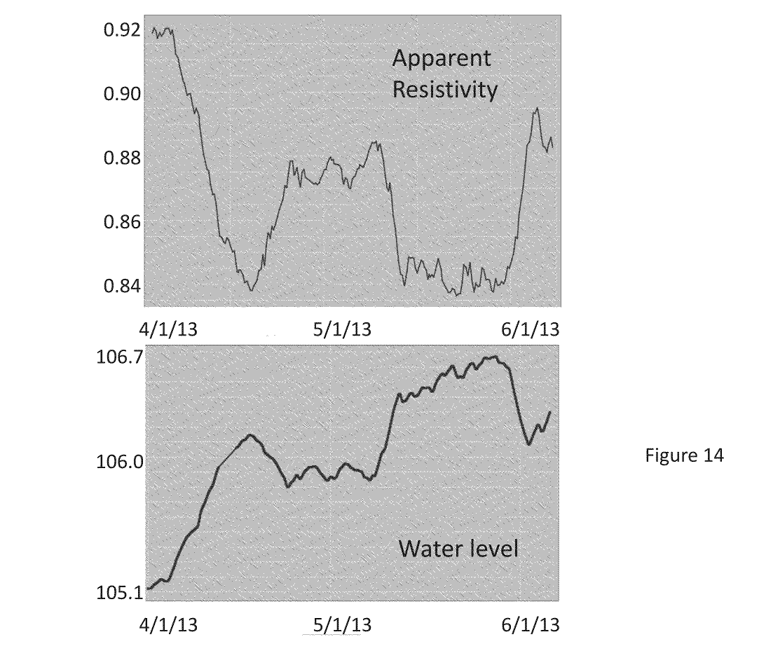

In the above, the process 112 to estimate changes in electrical properties in the subsurface can include, but is not limited to a number of techniques. These include (1) the use of directly measured changes in subsurface properties such as temperature, waterlevel or water chemistry, and the use of petrophysical or mapping functions between such properties and electrical properties. For instance, Archie's Law could be used to relate changes in fluid conductivity to changes in overall subsurface electrical properties. Another technique is direct assessment of changes in apparent resistivity for the same measurement during the dataset acquisition period. Another technique (as the temporal density of apparent resistivity measurements for a same configuration may be insufficient to determine changes in physical properties in a timely manner) is the determination of a correlation between apparent resistivity measurements and a dataset of physical, chemical or biological properties with a higher temporal density. For instance, FIG. 14 shows a graph of apparent resistivity for a specific resistivity measurement (which is collected every 6 hours) and a measurement of waterlevel in a well in the area which is being monitored (which is being collected every 15 minutes). It is clear that the rate and magnitude of changes in one parameter (the waterlevel) can be used to predict the change in the parameter of interest (apparent resistivity) which is a direct indicator of temporal changes in subsurface electrical properties.

112 generally has two main elements. These elements include (1) the discovery of relationships between the different timeseries, and (2) the use of these relationships to estimate a change in electrical properties in the subsurface over an acquisition period of a dataset.

The term “discovery of relationships” may refer in a broad sense, to any method which can be used to find the relationship between two datasets. Such methods may include, for example, the application of statistical methods such as (but not limited to) the calculation of covariance data, covariance matrixes and Cholesky decompositions, correlation coefficients, Pearson Product-moment correlation and/or the application of Principal Component Analysis. The term “discovery of relationships” also may include the application of neural networks and other mathematical tools.

As these relationships can vary over time, all elements in 112 may be executed in a continuos, or at least, repetitive loop which will ingest new data and update outputs continuously or periodically.

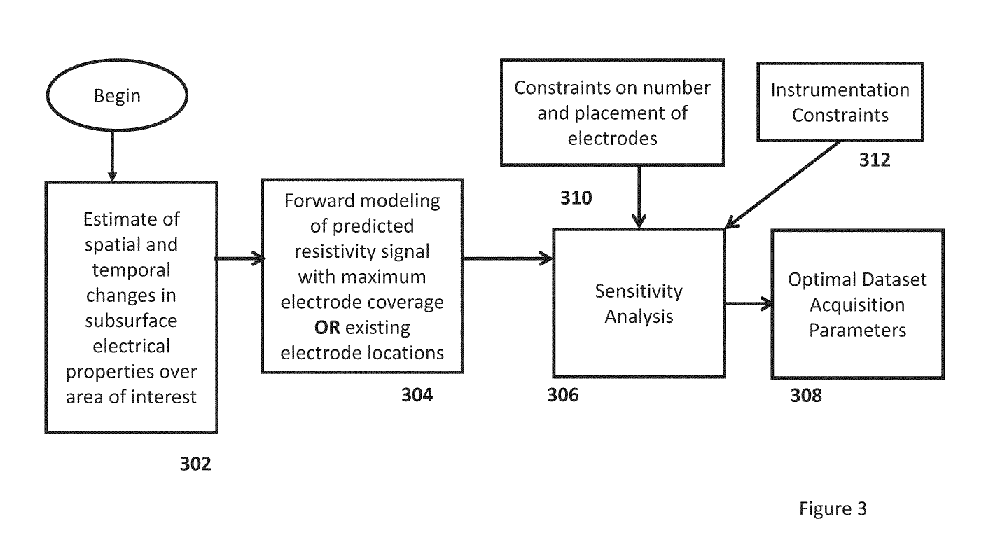

In steps 102 and 116 the data acquisition parameters are calculated for a dataset. Exemplary details of this calculation are shown in FIG. 3. This exemplary calculation uses an estimate of spatial and temporal changes in subsurface properties over the area of interest (302). This estimate can be obtained in different ways. It can be obtained from the process shown in FIG. 1, or can be obtained from a combination of expert insights, modeling of subsurface processes and the application of petrophysical transforms and/or field measurements. This estimate serves as input to a forward electrical resistivity modeling code (304). Such codes can predict the measured resistivity signal for a specific distribution of subsurface electrical properties and electrode locations. In 304 such a code could use either existing electrode locations OR a spatially dense electrode distribution (The definition of spatially dense should be clear to a practitioner in the field, but as an example an electrode distribution in which electrodes are placed at spacings of 1 meters in all directions in a model of 300 meter by 300 meter (surface dimension) by 30 meter (depth dimension) would classify as a spatially dense electrode distribution).

The results of the forward modeling, as well as constraints 310 on number and placement of electrodes (in the case that this number and placement has not yet been decided) and instrumentation constraints 312 is input into a sensitivity analysis 306 which finds the optimum dataset acquisition parameters 308 which are used in the embodiment of the invention shown in FIG. 1.

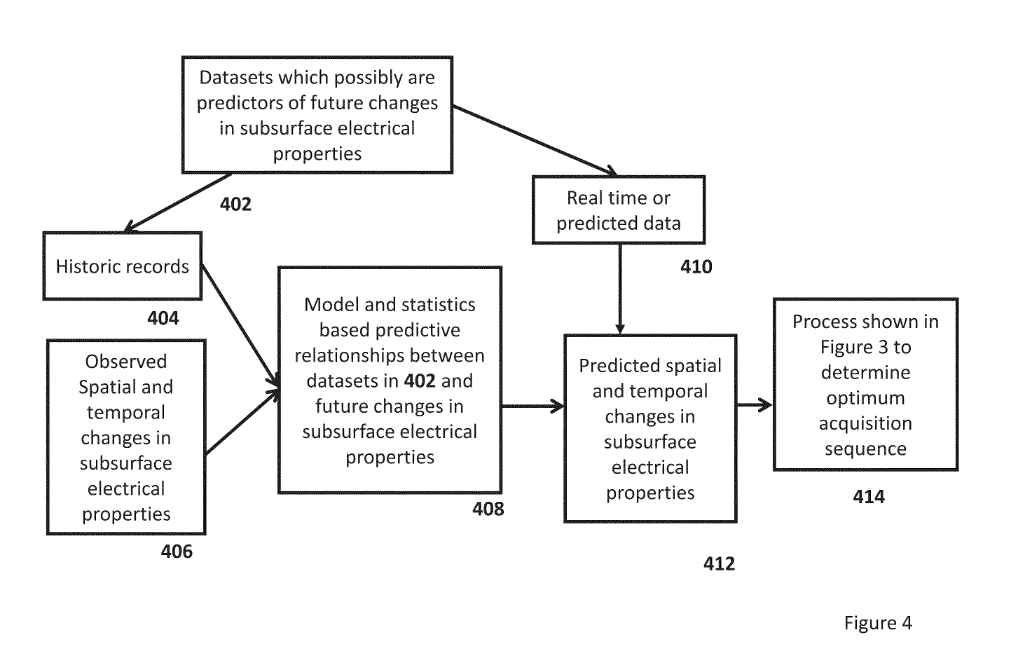

In some embodiments, future data acquisition parameters may be determined based on datasets which are predictive of future changes in subsurface electrical conductivity. A flow chart of this is shown in FIG. 4. In this embodiment, datasets, which are possibly predictors of changes in subsurface electrical properties (402), may be used in two ways. First, historic records of such datasets (404) may be used in conjunction with observed spatial and temporal changes in subsurface electrical properties (406) to develop model and statistics based predictive relationships 408 between the data in 402 and future changes in subsurface electrical properties. Second, real time or predicted data records of these datasets (410) may be used to predict spatial and temporal changes in subsurface electrical properties (12). This data may be used in conjunction with 414—the process shown in FIG. 3 to determine an optimum acquisition sequence. Non exclusive examples of the datasets which could be used in the embodiment shown in FIG. 4 are data from streamgages located upstream from the resistivity system site, data from weatherstations and weatherpredictions, and predicted data from anthropogenic activities (for instance, injections or extractions of fluids in the subsurface).

Data processing of electrical geophysical inversion includes both preprocessing and inversion. In a preprocessing phase, algorithms may be applied to the field measurements which have as a purpose to select those measurements which will be used in the inversion phase, and to assign confidence and error estimates to those field measurements. Thus, the input of the preprocessing may be a dataset of measurements, and the output may be a subset of those measurements and associated confidence and error estimates for this subset. The output of the preprocessing is the input to the inversion step.

The objective of the inversion step is to obtain an electrical conductivity model M which best represents the actual electrical resistivity distribution of the subsurface. This is an ill-posed problem and the accepted solution to this is to solve an inverse problem which minimizes a cost function which includes both a data misfit, regularizations and constraints.

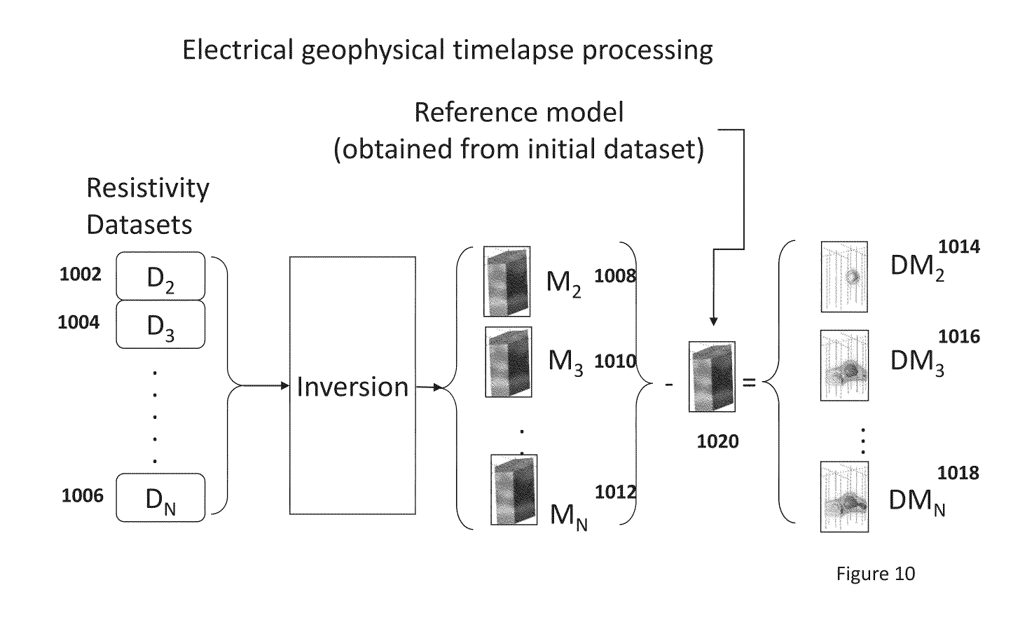

The objective of timelapse electrical geophysics is to obtain accurate information on changes in subsurface electrical properties. This is done by processing the individual datasets in a timelapse survey, and using the changes in electrical property models between each dataset. An example of how this processing flow can be implemented is shown in FIG. 10. The changes in subsurface electrical properties are shown in this figure as 1014, 1016 and 1018. These changes are obtained from processing the individual datasets. One such way of processing is shown in the left of FIG. 10. Other ways should be obvious to those skilled in the art. In the way of processing shown in FIG. 10 individual resistivity datasets 1002, 1004, 1006 are inverted. Each dataset results in a distribution of electrical properties 1008, 1010, 1012. These datasets are then subtracted from a reference model 1020 obtained from an initial dataset to produce the changes in subsurface electrical properties 1014, 1016 and 1018. Other ways of timelapse processing are possible than the ones shown in FIG. 10, however all of these ways have as objective to obtain accurate information on changes in subsurface electrical properties, and all of these use the resistivity datasets and associated processing parameters.

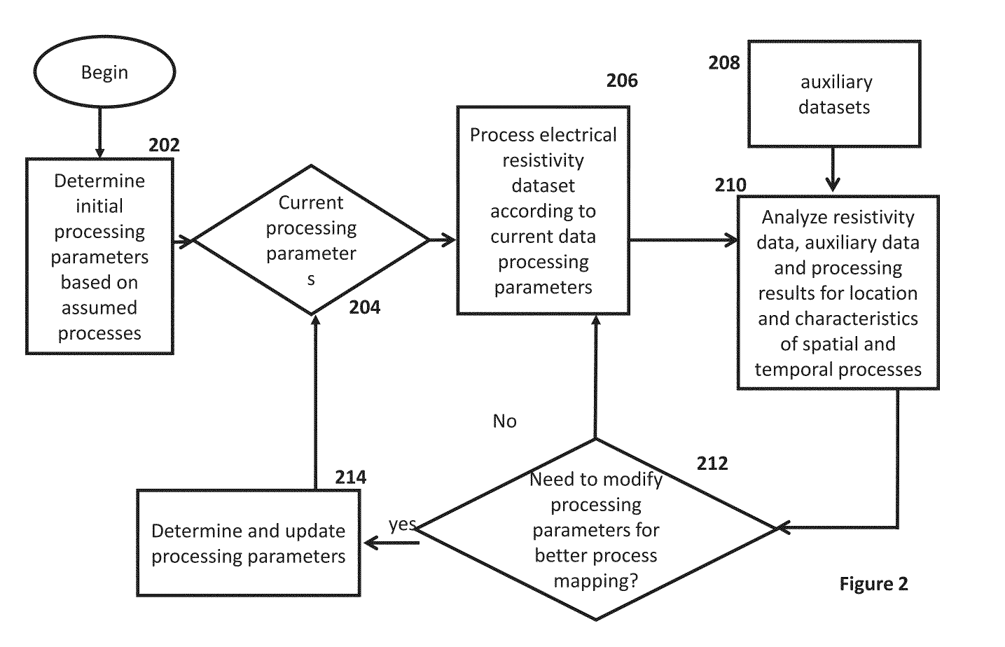

Another embodiment, provides a system for assessing and adapting the processing parameters used in the inversion of timelapse electrical geophysical datasets. This embodiment is focused on ensuring that the model resulting from the processing of timelapse electrical geophysical data is as true as possible of a representation of the actual distribution of electrical properties. An example of this embodiment is shown in FIG. 2. In this embodiment, initial constraints are determined (202) for a specific suite of processes and assumed subsurface distribution of properties. The result of this determination is stored as “current processing parameters” 204. Subsequent to the initial calculation an electrical resistivity dataset is processed (206). This is followed by an analysis which uses the resistivity data, auxiliary data (208) and processed resistivity data to determine the location and characteristics of spatial and temporal processes (210). These changes are transmitted to analysis logic (212) which decides whether the processing parameters used in the inversion need to be modified. If the processing parameters need to be modified novel processing parameters are determine (214) and the processing parameters 204 used by the system are updated.

In the above, the process (210) to determine the location and characteristics of spatial and temporal processes can include for example the use of directly measured changes in subsurface properties such as temperature, waterlevel or water chemistry, and the use of petrophysical or mapping functions between such properties and electrical properties as well as the use of modeling results of the effects of spatial processes on electrical properties. In one example, Archie's Law or an experimental site specific relationship may be used to relate changes in directly measured properties to changes in overall subsurface electrical properties which would be used as constraints. In another example, the result of a prediction of, e.g., a wetting front resulting from rainfall and the subsequent mapping of this wetting front to changes in electrical properties may be used to give the location and characteristics of electrical properties.

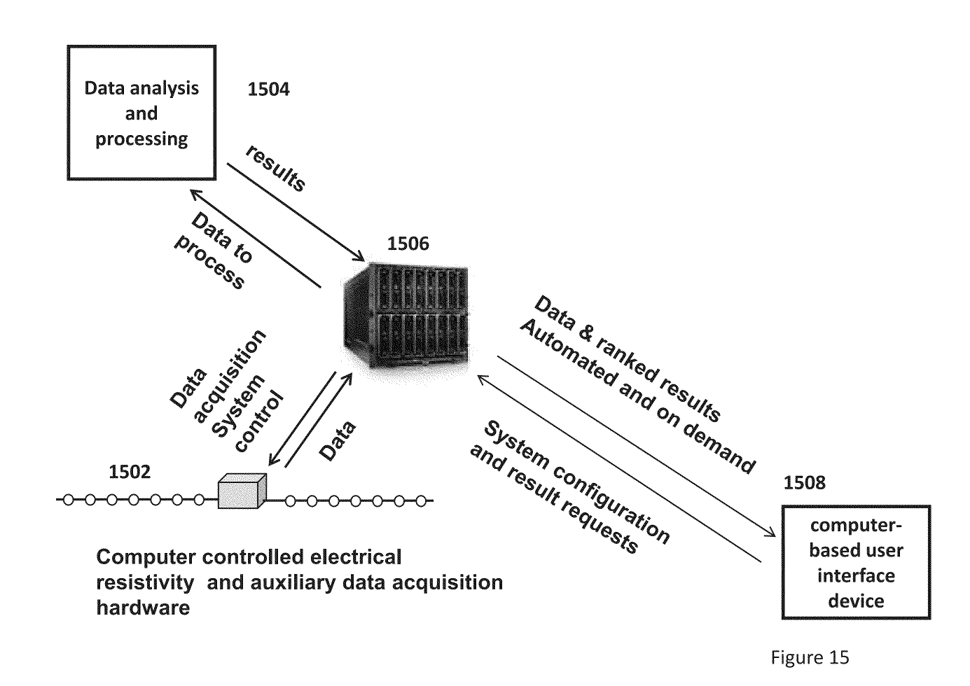

Another embodiment provides a system and software for transmission, validation, management, storage of and user interaction with time-series electrical geophysical and auxiliary data and instrumentation. An example of this embodiment is shown in FIG. 15. Data is collected by different data acquisition devices (1502). Data is then transmitted to a central analysis computer 1506 using electronic file transfer protocols. Data is received at the central computer and stored in a structured format. Datasets are inverted into a spatiotemporal model of subsurface electrical properties by process 1504 which represents, for example, the methods discussed previously for inversion.

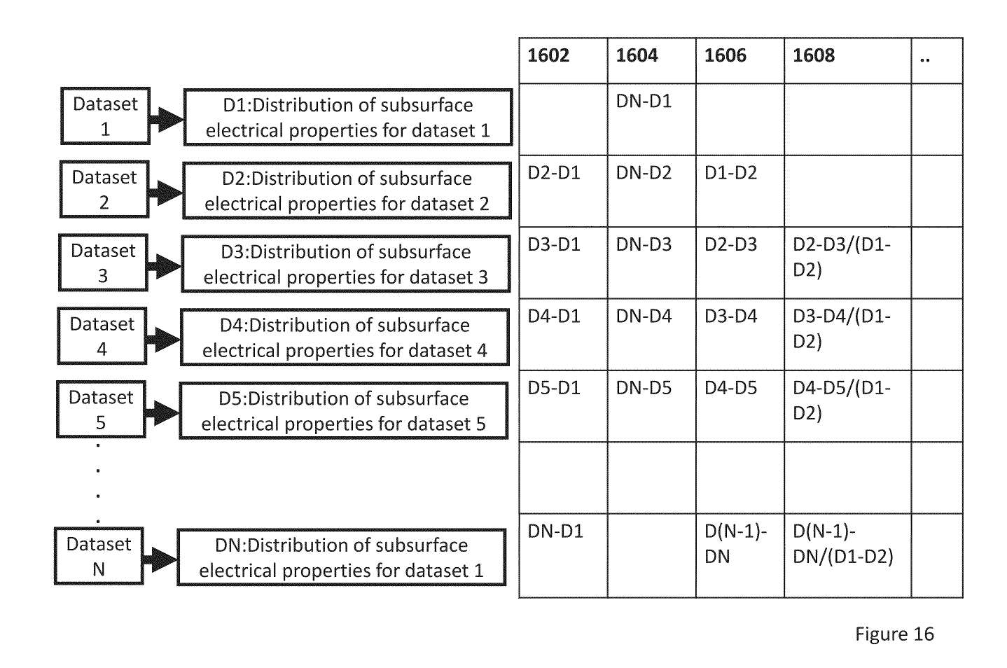

The models of electrical properties resulting from the processing of different datasets can be used to generate different derived data products. FIG. 16 shows some examples of such derived data products. Each dataset produces a distribution of subsurface electrical properties. Different mathematical operations are used to generate data products. These mathematical operations include 1602: the difference between models and the first model (P1), 1604: the difference between models and the last model (P2), 1606: the difference between subsequent models (P3) and 1608: normalized differences. These data products are provided as indicative examples: other data products are possible which can be generalized in different classes, such as differences between models, ratios between models, correlations between models and other datasets and statistical analyses. These data products can be readily generated and stored on cloud based High Performance Computing infrastructure. As the number of data products increases exponentially with the number of models, it is generally impractical for users to manually investigate all possible derived data products.

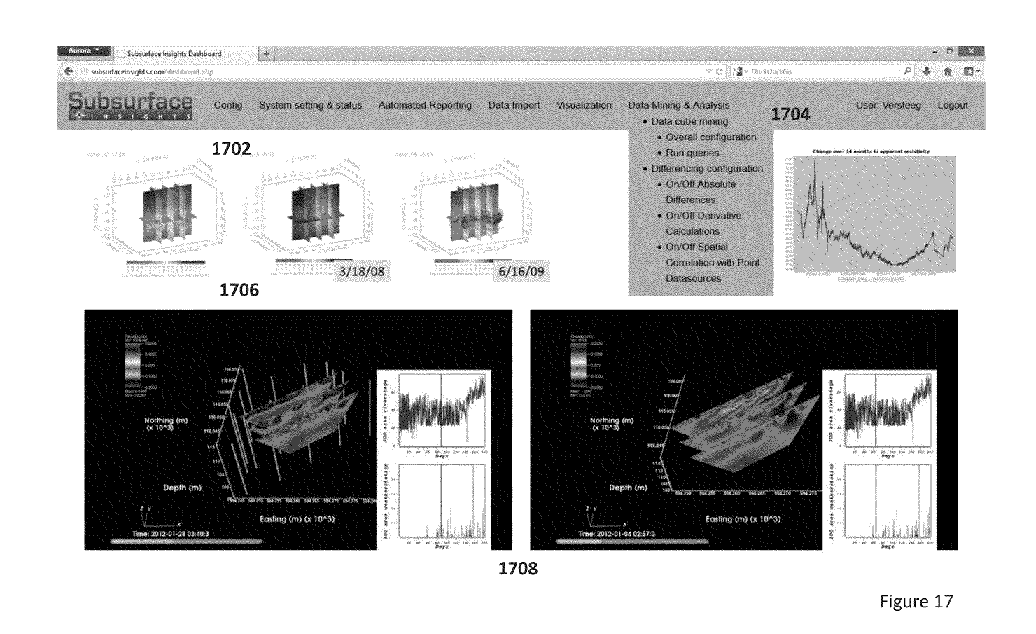

In the embodiment shown in FIG. 15, users can interactively visualize, query and interact with different datasets, models and ranked derived data products through map or text based interfaces. An example of a computer-based user interface is shown in FIG. 17. Through this interface users can configure the system parameters 1702.

Data products could be generated using data mining and analysis tools which uses the output of the inversion, resistivity measurements, auxiliary datasets and datasets provided by the user (1704). Users can visualize data products based on their information rank (1706 and 1708). Criteria on which users may base their rank may include, for instance, high changes or change ratios between datasets, changes in specific locations, and/or changes at specific times. Users would interact with this system through a variety of software clients, including browsers and general purpose applications.

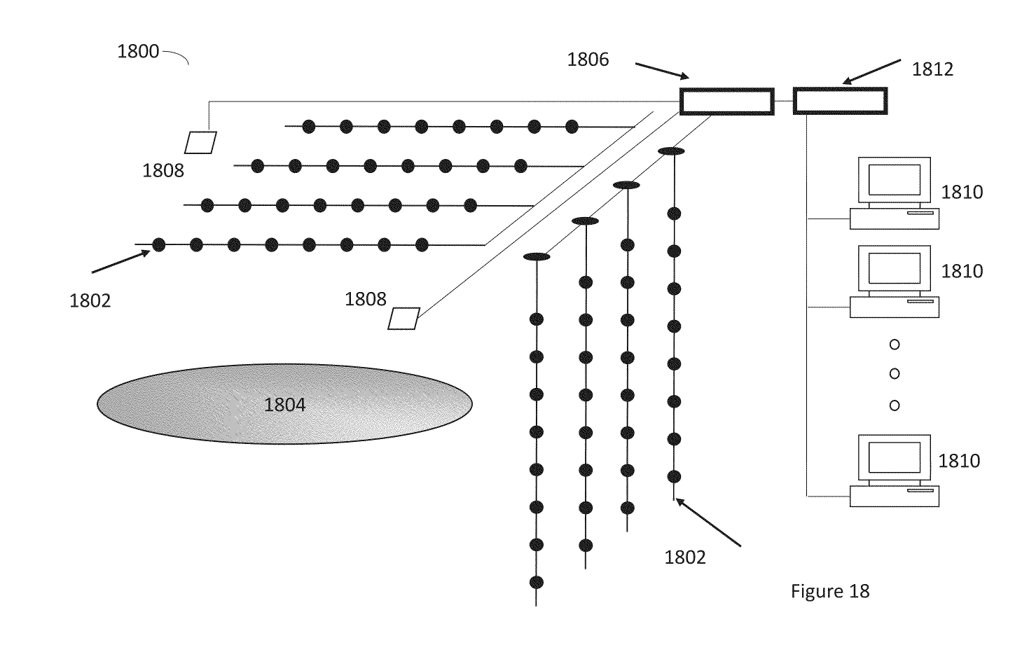

FIG. 18 is a schematic representation of an exemplary computer system 1800.

The illustrated computer system 1800 includes a resistivity acquisition system 1806 connected to electrodes 1802 which are arranged to measure electrical resistivity (and/or other electrical characteristics, such as conductivity) in or around a subsurface area of interest 1804. The illustrated system 1800 has sixty-four individual electrodes. However, different systems can have different numbers of electrodes.

In the illustrated system 1800, half of the electrodes (i.e., the ones that are connected to the horizontally-disposed lines in FIG. 18) are arranged in a substantially horizontal plane at or just beneath the earth's surface and half of the electrodes (i.e., the ones that connected to the vertically-disposed lines in FIG. 18) are arranged in one or more boreholes, beneath the earth's surface. Different systems can have different electrode arrangements.

During operation, in a typical implementation, one or more of the electrodes 1802 act as a source of electrical current into the earth and one or more of the electrodes 1802 act as a return path for the electrical current from the earth. These may be referred to as “current electrodes” or “injection electrodes.” In addition, during operation, in a typical implementation, one or more pairs of electrodes act to measure electrical potential between them. These may be referred to as “potential electrodes” or “measurement electrodes.”

Typically, each time the system 1800 takes a measurement, the measurement electrodes measure the electrical potential while the current electrodes are passing current. The specific electrodes that act as “current electrodes” and the specific electrodes that act as “measurement electrodes” can change from measurement to measurement. In fact, during some measurements, one or more (or many) of the electrodes may not be used in either role; and the specific electrodes that are used can change from measurement to measurement. Other parameters related to acquiring a measurement can be modified from measurement to measurement as well.

In a typical implementation, the system 1800 is operational to modify the acquisition parameters in an ongoing manner (e.g., following each measurement, if warranted).

The illustrated system 1800 has a computer-based modeling system 1812 connected to the resistivity acquisition system 1806. In a general, the resistivity acquisition system 1806 controls the data acquisition per the parameters provided by the computer based modeling system 1812. The resistivity acquisition system 1806 transmits the collected data to the computer modeling system 1812 in an ongoing manner (possibly after each measurement if warranted). The computer based modeling system 1812 receives the collected data from the resistivity acquisition system 1806, processes the data in an ongoing manner and provides user access to system information. The computer based modeling system 1812 assesses acquisition and processing parameters in an ongoing manner. The computer based modeling system 1812 can transmit updated acquisition parameters to the resistivity acquisition system 1806 in an ongoing manner (possibly after each measurement if warranted).

In general, the modeling system 1812 processes the data it receives from the resistivity acquisition system 1806 using processing parameters. In a typical implementation, the system 1800 is operable to modify the processing parameters in an ongoing manner (e.g., following each measurement, if warranted).

Although the computer-based modeling system 1812 in the illustrated system 1800 is shown as a single, integrated component, in various embodiments, the functionalities associated with the computer-based modeling system 1812 can be distributed across different components at different, even remote, locations.

The illustrated system 1800 has two auxiliary data sensors 1808. In general, an auxiliary data sensor is an in-ground or above-ground physical, chemical or biological sensor configured to collect data that is relevant to the subsurface area of interest. Examples include a weatherstation or a temperature sensor. Different systems can have different numbers of auxiliary data sensors 1808. Indeed, some systems may have no auxiliary data sensors at all.

The illustrated system 1800 also has a plurality of computer-based user interface devices 1810 that are coupled to the computer-based modeling system 1812.

The user interface devices 1810 can be any type of computer-based device that enables a human user to access data and interact with computer-based technology. For example, the user interface devices 1810 can be personal computers or workstations.

In a typical implementation, the user interface devices 1810 are coupled to the modeling system 1812 over a network (e.g., the Internet).

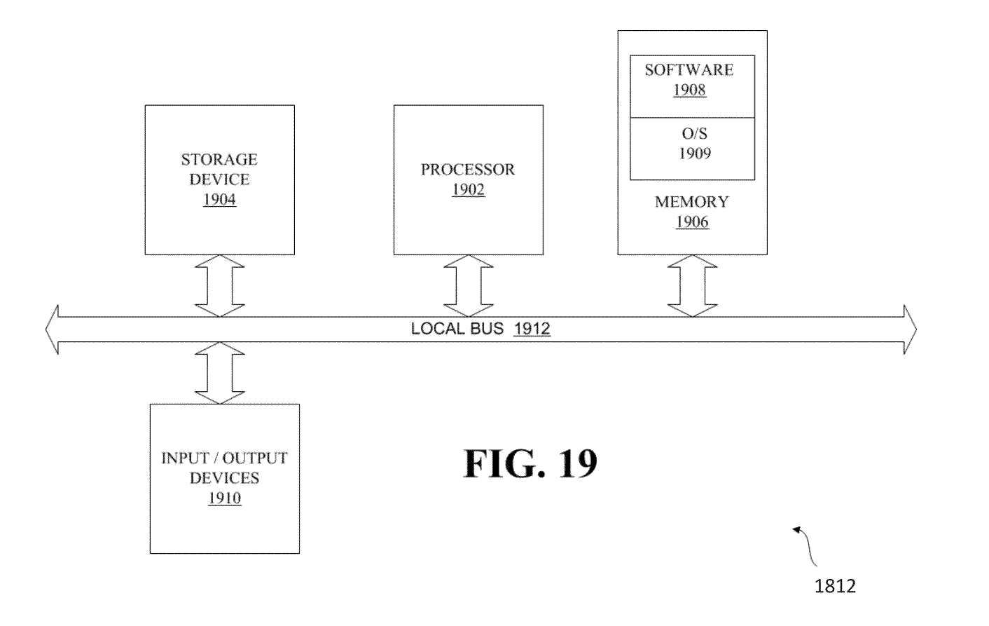

FIG. 19 is a schematic diagram illustrating an example of the computer-based modeling system 1812. In general, the modeling system 1812 is configured to execute and/or facilitate one or more of the system functionalities described herein.

The illustrated modeling system 1812 has a processor 1902, a storage device 1904, a memory 1906 having software 1908 stored therein that, when executed by the processor, causes the processor to perform or facilitate one or more of the functionalities described herein, input and output (I/O) devices 1910 (or peripherals), and a local bus, or local interface 1912 allowing for communication within the modeling system 1812. The local interface 1912 can be, for example, one or more buses or other wired or wireless connections. The modeling system 1812 may have additional elements, which are omitted for simplicity, such as controllers, buffers (caches), drivers, repeaters, and receivers, to facilitate communications and other functionalities. Further, the local interface 1912 may include address, control, and/or data connections to enable appropriate communications among the illustrated components.

The processor 1902 is a hardware device for executing software, particularly that stored in the memory 1906. The processor 1902 can be any custom made or commercially available single core or multi-core processor, a central processing unit (CPU), an auxiliary processor among several processors associated with the present modeling system 1812, a semiconductor based microprocessor (in the form of a microchip or chip set), a macroprocessor, or generally, any device for executing software instructions.

The memory 1906 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 1906 may incorporate electronic, magnetic, optical, and/or other types of storage media. The memory 1906 can have a distributed architecture, where various components are situated remotely from one another, but can be accessed by the processor 1902.

The software 1908 defines various aspects of the modeling system functionality. The software 1908 in the memory 1906 may include one or more separate programs, each of which contains an ordered listing of executable instructions for implementing logical functions of the modeling system 1812; as described herein. The memory 1906 may contain an operating system (O/S) 1909. The operating system essentially controls the execution of programs within the modeling system 1812 and provides scheduling, input-output control, file and data management, memory management, and communication control and related services.

The I/O devices 1910 may optionally include one or more of any type of input or output device(s). Examples include a keyboard, mouse; scanner, microphone, printer; display, etc. The I/O devices 1910 may include one or more devices that communicate via both inputs and outputs, for instance a modulator/demodulator modem; for accessing another device, system, or network), a radio frequency (RE) or, other transceiver, a telephonic interface, a bridge, a router, or other device. In some implementations, the user having administrative privileges may access the system to perform administrative functions through the I/O devices 1910.

In general, when the modeling system 1812 is in operation, the processor 1902 executes the software 1908 stored within the memory 1906, communicates data to and from the memory 1906, and generally controls operations of the modeling system 1812 pursuant to the software 1908.

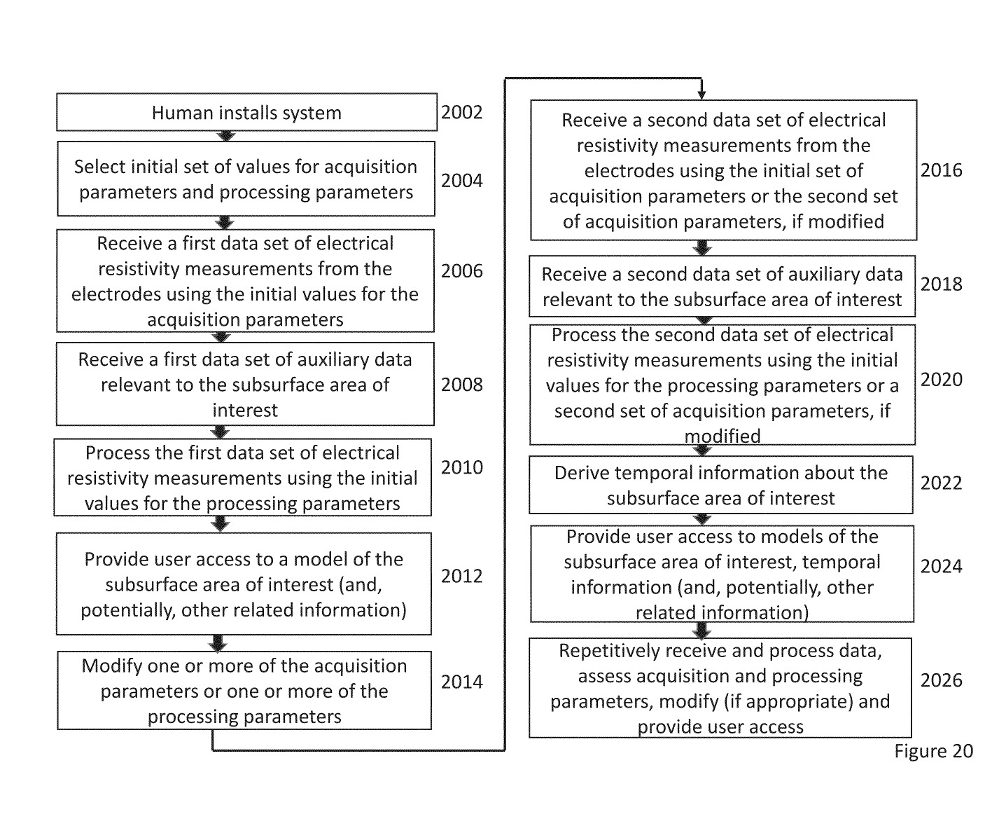

FIG. 20 is a flowchart of a method associated with the system 1800 of FIG. 18.

According to the illustrated method, a human, at 2002, installs and sets the system up. In a typical implementation, this includes arranging the electrodes to measure electrical resistivity (or other characteristics) in or around a sub-surface area of interest, installing and setting up the auxiliary data sensors, if any, the computer-based modeling system and the user interface devices. IN some implementations, one or more of these may be omitted. Moreover, in some implementations, at least some of the system hardware may already be in place and system installation may be as simple as a software upgrade and/or minor system adjustments.

According to the illustrated method, the human, at 2004, selects an initial set of values for the system to use as acquisition parameters and processing parameters. In a typical implementation, these values are entered into the system via a user-interface at the modeling system 1812 or one of the user interface devices 1910. The values may be stored, for example, in the memory device 1906 of the modeling system 1812.

In a typical implementation, the acquisition parameters include one or more of the following: an identification of which specific electrodes are to be involved in individual measurements, an identification of which specific electrodes will act as a current electrode and which of the specific electrodes involved in each individual measurement will act as a potential electrode, an order in which to make individual measurements, a value of source current or voltage to be used in each individual measurement, a number of frequencies and frequency values to use for each specific electrode combination used in an individual measurement, a total length of an induced polarization window associated with each individual measurement, and a number of measurements to be taken to characterize an induced polarization response for each individual measurement.

In a typical implementation, the processing parameters include one or more of the following: weights to be assigned to the electrical resistivity measurements during processing, data misfit criteria to be used in optimization processes, temporal constraints, spatial constraints, weights to be assigned to the temporal or spatial constraints in an inversion process, and threshold values to guide the inversion process.

According to the illustrated method, the modeling system 1812 receives a first data set of electrical resistivity measurements from the electrodes, at 2006. This first data set is obtained by the electrodes using the initial values for the acquisition parameters. Thus, the electrodes operate to inject current and measure potential, as dictated by the applicable, initial acquisition parameters, and provides the results of this measurement to the modeling system 1812.

According to the illustrated implementation, the modeling system 1812, at 2008, receives a first data set of auxiliary data relevant to the subsurface area of interest. The modeling system 1812 receives this data from one or both of the auxiliary data sensors 1808.

At 2010, the modeling system 1812 processes the first data set of electrical resistivity measurements using the initial values for the processing parameters. In some implementations, this processing step also takes into account any auxiliary data and/or other information input, for example, by a user at one of the user interface devices 1810. In a typical implementation, this processing step produces a model of the subsurface area of interest 1804.

At 2012, the system 1800 provides user access to the model of the subsurface area of interest (and, potentially, other related information, as well). In some implementations, the system 1800 accomplishes this by having the modeling system 1812 act as a web server and enabling users to access information via a web browser at one or more of the user interface devices 1810. However, access can be provided in a number of other ways as well.

At 2014, the system assesses the various parameters and, if appropriate, modifies one or more of the acquisition parameters or one or more of the processing parameters. In a typical implementation, these modifications are made in consideration of one or more queries, features of interest, data attributes, information objectives, etc. specified by a user, for example, at one of the user interface devices 1810. For example, if a user at one of the user interface devices specifies that an event of significance (e.g., a rainfall or a rise or fall in the groundwater table) is expected to happen at a particular time, or if the auxiliary data so indicates, then the system 1800 may modify one or more of the acquisition parameters or processing parameters in order to focus on that event and its effects on the subsurface area of interest during the associated period time. There may be other reasons to modify parameters as well.

After modifying (or at least considering a modification to) one or more of the acquisition parameters or processing parameters, the resistivity acquisition system 1806 operates accordingly to obtain a second data set of electrical resistivity measurements. According to the illustrated method, the modeling system 1812, at 2016, receives the second data set of electrical resistivity measurements from the electrodes using the initial set of acquisition parameters or the second set of acquisition parameters, if modified.

The modeling system 2016, at 2018, also receives a second data set of auxiliary data relevant to the subsurface area of interest.

The modeling system 2016, then processes the second data set of electrical resistivity measurements, at 2020, using the initial values for the processing parameters or the second set of acquisition parameters, if modified. In some implementations, this processing step also takes into account any auxiliary data and/or other information input, for example, by a user at one of the user interface devices 1810. In a typical implementation, this processing step produces a second model of the subsurface area of interest 1804.

At this point, with multiple models of the subsurface area of interest 1804 at different times, the system 1800 derives, at 2022, temporal information about the subsurface area of interest 1804. This temporal information may include, for example, an identification of significant changes in various aspects of the subsurface area of interest 1804. The assessment of significance may be implemented in view of queries, features of interest, data attributes, information objectives, etc. specified by a user, for example, at one or more of the user interface devices 1810.

In some implementations, deriving the temporal information involves one or more of the following mathematical techniques: taking a difference between two models, taking a difference between several averaged models, taking a ratio, calculating a gradient. Other mathematical operations may be involved in deriving the temporal information as well. In some implementations, the system 1800 or a system user may specify the mathematical operation(s) that best conveys certain information about the temporal nature of the subsurface area of interest 1804.

The system, at 2024, provides users access to the models of the subsurface area of interest 1804, the temporal information (and, potentially, other related information). In a typical implementation, users can access this information from any of the user interface devices 1810.

According to the illustrated method, the system 1800, at 2026, repetitively receives and processes data, assesses acquisition and processing parameters and modifies (if appropriate) the acquisition and processing parameters and provides users access to the various information in a timely manner.

A number of embodiments have been described. Nevertheless, it will be understood that various modifications may be made without departing from the spirit and scope of the present disclosure.

For example, embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Other implementations are within the scope of the claims.

What is claimed is:

1. A computer-based method comprising:
receiving a first data set of electrical resistivity measurements from a plurality of electrodes arranged to measure electrical resistivity in or around a subsurface area of interest using a first set of acquisition parameters;
processing, with one or more computer-based processors, the first data set of electrical resistivity measurements using a first set of processing parameters to produce a first multi-dimensional model of electrical resistivity in the subsurface area of interest; and
modifying one or more of the acquisition parameters or one or more of the processing parameters.

2. The computer-based method of claim 1, wherein modifying the one or more acquisition parameters or modifying the one or more processing parameters is based, at least in part, on one or more multi-dimensional models of electrical resistivity.

3. The computer-based method of claim 1, wherein modifying the one or more acquisition parameters or modifying the one or more processing parameters is based, at least in part, on individual measurements of electrical resistivity.

4. The computer-based method of claim 1, wherein modifying the one or more acquisition parameters or modifying the one or more processing parameters is based, at least in part, on auxiliary data.

5. The computer-based method of claim 4, further comprising:
receiving the auxiliary data from one or more in-ground or above-ground physical, chemical or biological sensors relevant to the subsurface area of interest.

6. The computer-based method of claim 4, wherein the auxiliary data is used in an inversion process or an optimization process to modify one or more of the acquisition parameters or one or more of the processing parameters.

7. The computer-based method of claim 1, further comprising:
receiving a second data set of electrical resistivity measurements from the plurality of electrodes associated with the subsurface area of interest, wherein the second data set of electrical resistivity measurements is received later in time than the first data set of electrical resistivity measurements; and
processing, with the computer-based processor, the second data set of electrical resistivity measurements to produce a second multi-dimensional model of electrical resistivity in the subsurface area of interest,
wherein the second data set of electrical resistivity measurements is acquired using the second set of acquisition parameters or wherein the second data set of electrical resistivity measurements is processed using the second set of processing parameters.

8. The computer-based method of claim 7, wherein the second set of acquisition parameters is different than the first set of acquisition parameters or wherein the second set of processing parameters is different than the first set of processing parameters.

9. The computer-based method of claim 7, wherein the acquisition parameters include one or more of the following:
an identification of specific electrodes from the plurality of electrodes to be involved in each individual measurement,
an identification of which of the specific electrodes involved in each individual measurement will act as a current electrode and which of the specific electrodes involved in each individual measurement will act as a potential electrode,
an order in which to make the individual measurements,
a value of source current or voltage used in making each individual measurement,
a number of frequencies and frequency values to use for each specific electrode combination used in an individual measurement,
a total length of an induced polarization window associated with each individual measurement, and
a number of measurements to be taken to characterize an induced polarization response for each individual measurement.

10. The computer-based method of claim 7, wherein the processing parameters include one or more of the following: weights to be assigned to the electrical resistivity measurements, data misfit criteria used in optimization processes, temporal constraints, spatial constraints, weights to be assigned to the temporal or spatial constraints in an inversion process, and threshold values to guide the inversion process.

11. The computer-based method of claim 7, further comprising:
acquiring one or more subsequent data sets at different points in time; and
assessing the first data set of electrical resistivity measurements to determine whether the first set of acquisition parameters is correct; and
modifying the acquisition parameters for the subsequent datasets based on the assessment; or
assessing a result from processing the first data set of electrical resistivity measurements to determine whether the first set of processing parameters is correct; and
modifying the processing parameters for subsequent datasets based on the assessment.

12. The computer-based method of claim 7, further comprising:
providing access to information about the first multi-dimensional model or the second multi-dimensional model from a computer-based user interface device.

13. The computer-based method of claim 12, further comprising:
providing access to information about one or more other multi-dimensional models of the subsurface area of interest and auxiliary data related to the subsurface area of interest.

14. The computer-based method of claim 7, wherein each of the first and second multi-dimensional models is a spatial distribution model.

15. The computer-based method of claim 14, further comprising:
deriving temporal information about the subsurface area of interest by performing mathematical operations on two or more multi-dimensional models.

16. The computer-based method of claim 15, further comprising:
providing access to the temporal information about the subsurface area of interest from a computer-based user interface device.

17. The computer-based method of claim 1, further comprising:
initially arranging the plurality of electrodes to measure electrical resistivity in or around the subsurface area of interest;
selecting an initial set of values for the acquisition parameters to collect a resistivity dataset with said electrodes; and
selecting an initial set of values for the processing parameters to process said resistivity dataset to produce an initial multi-dimensional model of subsurface electrical resistivity.

18. The computer-based method of claim 17, wherein the number of electrodes, the locations of the electrodes, the initial set of values for the acquisition parameters and the initial set of values for the processing parameters are based on known or assumed subsurface properties and known or assumed spatial or temporal changes in electrical resistivity in or around the subsurface area of interest.

19. The computer-based method of claim 1, wherein the electrical resistivity is complex electrical resistivity defined as anisotropic, frequency-dependent, real and imaginary electrical resistivity.

20. The computer-based method of claim 1, further comprising providing access to data about results of the computer-based method from a computer-based user interface device.

21. The computer-based method of claim 20, wherein the data about the computer-based method includes one or more multi-dimensional models of the subsurface area of interest, auxiliary data related to the subsurface area of interest, temporal information about the subsurface area of interest obtained by performing mathematical operations on two or more multi-dimensional models, or processing and acquisition parameters.

22. The computer-based method of claim 21, wherein the data about the results of the computer-based method is automatically ranked in terms of relevancy to information objectives.

23. A computer-based system comprising:
a plurality of electrodes arranged to measure electrical resistivity in or around a subsurface area of interest; and
a computer-based modeling system coupled to the plurality of electrodes,
wherein the computer-based modeling system comprises one or more computer-based processors configured to:
receive a first data set of electrical resistivity measurements from the plurality of electrodes using a first set of acquisition parameters;
process the first data set of electrical resistivity measurements using a first set of processing parameters to produce a first multi-dimensional model of electrical resistivity in the subsurface area of interest; and
modify one or more of the acquisition parameters or one or more of the processing parameters.

24. The computer-based system of claim 23, wherein modifying the one or more acquisition parameters or modifying the one or more processing parameters is based, at least in part, on one or more multi-dimensional models of electrical resistivity, individual measurements of electrical resistivity or auxiliary data.

25. The computer-based system of claim 23, wherein the one or more processors is further configured to:
receive a second data set of electrical resistivity measurements from the plurality of electrodes associated with the subsurface area of interest, wherein the second data set of electrical resistivity measurements is received later in time than the first data set of electrical resistivity measurements; and
process the second data set of electrical resistivity measurements to produce a second multi-dimensional model of electrical resistivity in the subsurface area of interest,
wherein the second data set of electrical resistivity measurements is received using the second set of acquisition parameters or wherein the second data set of electrical resistivity measurements is processed using the second set of processing parameters.

26. The computer-based system of claim 25, wherein the second set of acquisition parameters is different than the first set of acquisition parameters or wherein the second set of processing parameters is different than the first set of processing parameters.

27. The computer-based system of claim 23, wherein the acquisition parameters include one or more of the following:
an identification of specific electrodes from the plurality of electrodes to be involved in each individual measurement,
an identification of which of the specific electrodes involved in each individual measurement will act as a current electrode and which of the specific electrodes involved in each individual measurement will act as a potential electrode,
an order in which to make the individual measurements,
a value of source current or voltage used in making each individual measurement,
a number of frequencies and frequency values to use for each specific electrode combination used in an individual measurement,
a total length of an induced polarization window associated with each individual measurement, and
a number of measurements to be taken to characterize an induced polarization response for each individual measurement; or
wherein the processing parameters include one or more of the following:
weights to be assigned to the electrical resistivity measurements,
data misfit criteria used in optimization processes,
temporal constraints,
spatial constraints,
weights to be assigned to the temporal or spatial constraints in an inversion process, and
threshold values to guide the inversion process.

28. The computer-based system of claim 23, wherein the one or more computer-based processors are further configured to:
acquire one or more subsequent data sets at different points in time; and either
assess the first data set of electrical resistivity measurements to determine whether the first set of acquisition parameters is correct; and
modify the acquisition parameters for the subsequent datasets based on the assessment; or
assess a result from processing the first data set of electrical resistivity measurements to determine whether the first set of processing parameters is correct; and
modify the processing parameters for subsequent datasets based on the assessment.

29. The computer-based system claim 23, wherein the one or more computer-based processors are further configured to:
derive temporal information about the subsurface area of interest by performing mathematical operations on two or more multi-dimensional models.

30. The computer-based system of claim 29, further comprising:
a computer-based user interface configured to enable access to one or more multi-dimensional models of the subsurface area of interest, the derived temporal information or auxiliary data related to the subsurface area of interest.

31. The computer-based system of claim 23, wherein the electrical resistivity is complex electrical resistivity defined as anisotropic, frequency-dependent, real and imaginary electrical resistivity.

32. A non-transitory, computer-readable medium that stores instructions executable by a processor to perform the steps comprising:
receiving a first data set of electrical resistivity measurements from a plurality of electrodes arranged to measure electrical resistivity in or around a subsurface area of interest using a first set of acquisition parameters;
processing, with one or more computer-based processors, the first data set of electrical resistivity measurements using a first set of processing parameters to produce a first multi-dimensional model of electrical resistivity in the subsurface area of interest; and
modifying one or more of the acquisition parameters or one or more of the processing parameters.

33. The non-transitory, computer-readable medium of claim 32, wherein modifying the one or more acquisition parameters or modifying the one or more processing parameters is based, at least in part, on one or more multi-dimensional models of electrical resistivity, individual measurements of electrical resistivity or auxiliary data.

34. The non-transitory, computer-readable medium of claim 32 storing further instructions executable by the processor to perform the step comprising:
receiving a second data set of electrical resistivity measurements from the plurality of electrodes associated with the subsurface area of interest, wherein the second data set of electrical resistivity measurements is received later in time than the first data set of electrical resistivity measurements; and
processing, with the computer-based processor, the second data set of electrical resistivity measurements to produce a second multi-dimensional model of electrical resistivity in the subsurface area of interest,
wherein the second data set of electrical resistivity measurements is acquired using the second set of acquisition parameters or wherein the second data set of electrical resistivity measurements is processed using the second set of processing parameters.

35. The non-transitory, computer-readable medium of claim 32, wherein the second set of acquisition parameters is different than the first set of acquisition parameters or wherein the second set of processing parameters is different than the first set of processing parameters.

36. The non-transitory, computer-readable medium of claim 32, wherein the acquisition parameters include one or more of the following:
an identification of specific electrodes from the plurality of electrodes to be involved in each individual measurement,
an identification of which of the specific electrodes involved in each individual measurement will act as a current electrode and which of the specific electrodes involved in each individual measurement will act as a potential electrode,
an order in which to make the individual measurements,
a value of source current or voltage used in making each individual measurement,
a number of frequencies and frequency values to use for each specific electrode combination used in an individual measurement,
a total length of an induced polarization window associated with each individual measurement, and
a number of measurements to be taken to characterize an induced polarization response for each individual measurement; or
wherein the processing parameters include one or more of the following:
weights to be assigned to the electrical resistivity measurements,
data misfit criteria used in optimization processes,
temporal constraints,
spatial constraints,
weights to be assigned to the temporal or spatial constraints in an inversion process, and
threshold values to guide the inversion process.

37. The non-transitory, computer-readable medium of claim 32 storing further instructions executable by the processor to perform the steps comprising:
acquiring one or more subsequent data sets at different points in time; and either assessing the first data set of electrical resistivity measurements to determine whether the first set of acquisition parameters is correct; and
modifying the acquisition parameters for the subsequent datasets based on the assessment; or
assessing a result from processing the first data set of electrical resistivity measurements to determine whether the first set of processing parameters is correct; and
modifying the processing parameters for subsequent datasets based on the assessment.

38. The non-transitory, computer-readable medium of claim 32 storing further instructions executable by the processor to perform the step comprising:
deriving temporal information about the subsurface area of interest by performing mathematical operations on two or more multi-dimensional models.

39. The non-transitory, computer-readable medium of claim 32, wherein the electrical resistivity is complex electrical resistivity defined as anisotropic, frequency-dependent, real and imaginary electrical resistivity.
